(19) United States
(12) Patent Application Publication
(10) Pub. No.: US 2019/0047920 A1
(43) Pub. Date: Feb. 14, 2019

(54) Apparatus and Method for Inflating In-Space Gossamer Structures with Solid-State Gas Generator Arrays

(71) Applicant: BOARD OF TRUSTEES OF THE UNIVERSITY OF ARKANSAS, Fayetteville, AR (US)

(72) Inventors: Morgan Andrew Roddy, Fayetteville, AR (US); Po-Hao Adam Huang, Fayetteville, AR (US)

(73) Assignee: BOARD OF TRUSTEES OF THE UNIVERSITY OF ARKANSAS, Fayetteville, AR (US)

(21) Appl. No.: 16/058,955

(22) Filed: Aug. 8, 2018

Related U.S. Application Data
(60) Provisional application No. 62/543,202, filed on Aug. 9, 2017.

(51) Int. Cl. C06D 5/04; C06B 35/00

(52) U.S. Cl. CPC C06D 5/04; B64G 1/22; C06B 35/00

(57) ABSTRACT

A micro gas generator having a housing that contains one or more heating units. The heating units are independently operable. Each of the heating units contains a heating element and gas producing material.

### RELATED APPLICATIONS

This application claims the benefit of U.S. Provisional Application No. 62/543202, filed Aug. 9, 2017, which is herein incorporated by reference

### STATEMENT REGARDING FEDERALLY SPONSORED RESEARCH & DEVELOPMENT

The invention was developed under a SSTP Technology Partnership grant from NASA, grant number NNX15AW38A. The government has certain rights in the invention.

### INCORPORATION BY REFERENCE OF MATERIAL SUBMITTED ON A COMPACT DISC

Not applicable.

### FIELD OF THE INVENTION

Inflatable structures on spacecraft are a topic of considerable interest today. There are numerous valuable capabilities that could be added to a spacecraft by incorporating inflatables. Fundamentally speaking, an inflatable allows a spacecraft to increase its size, shape, or reach. In the context of small spacecraft where power, volume, and mass are extreme premiums, it can be a significant challenge to inflate structures due to the typical requirement of a complex inflation system.

### BRIEF SUMMARY OF THE INVENTION

In certain embodiments, the present invention provides a new way of inflating structures that are best in class regarding mass, cost, volume, system complexity. In certain aspects, the invention has zero moving parts, has built-in redundancy due to its architecture, and provides safe inflation by avoiding overpressuring, under pressuring, and high dynamic pressures.

In other embodiments, the present invention provides spacecraft subsystems with enhanced capabilities without significantly increasing system complexity. Due to the fact that the amounts of gas are very small (on the order of micrograms), there are no obvious terrestrial applications of this technology as this amount of gas has insignificant volume at atmospheric pressure.

In other embodiments, the present invention provides a device and method for inflating inflatable in-space or extraterrestrial structures.

The embodiments of the present invention are superior to other inflating structures in space. There are two typical ways of inflating structures and one proposed (no known demonstration) method. The first method uses a pressurized container of gas and a valve. This is straightforward in terrestrial applications but becomes complicated in space. Valves must be used redundantly to ensure mission success in the event of a failed valve. This means that four valves are typically used where one would normally be required (in terrestrial applications), leading to higher cost, space, and mass requirements on a spacecraft. The second method is to use a subliming material. The volume of the structure to be inflated and the desired pressure determines the required mass of subliming material. This gas generation method is reliable but can only be controlled by controlling the temperature of the subliming material. Once the material has fully sublimed, no more gas can be generated. Additionally, it is impossible to only sublime part of the material without the incorporation of a separate container for the material and a set of valves. Both of these methods have been used in the past but have the issues described. Another proposed method would be to use a cold gas generator to inflate. Such devices are on the market but are designed to pressurize propellant tanks, not to inflate structures. The issue with using this technology is that the gas is rapidly generated and is a one-time use device.

The embodiments of the present invention are superior to the aforementioned methods for several reasons. In one aspect, the embodiments of the present invention do not require any valves or other moving parts to operate, reducing system complexity, mass, and cost.

In other embodiments, the present invention does not need to generate all its gas capacity at once and can generate gas at any time, giving more flexibility of use.

In other embodiments, the present invention has built-in redundancy due to the fact that there is an array of gas generators.

In other embodiments, the present invention can maintain inflation of structures by periodically generating more gas to overcome any leaks.

In other embodiments, the present invention is superior to other methods by providing enhanced flexibility and reliability and reduced cost and system complexity.

In another embodiment, the present invention provides an inflatable device and method of inflating the same, that does not require any valves or other moving parts to operate, reducing system complexity, mass, and cost by directly releasing the gas into the inflatable structure.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings generally illustrate, by way of example, but not by way of limitation, a detailed description of certain embodiments discussed in the present document.

FIG. 1 illustrates a system overview for one embodiment of the present invention.

FIG. 2 illustrates yet another embodiment of the present invention.

FIG. 3 is a circuit schematic for another embodiment of the present invention.

FIG. 4 provides a perspective view of another embodiment of the present invention.

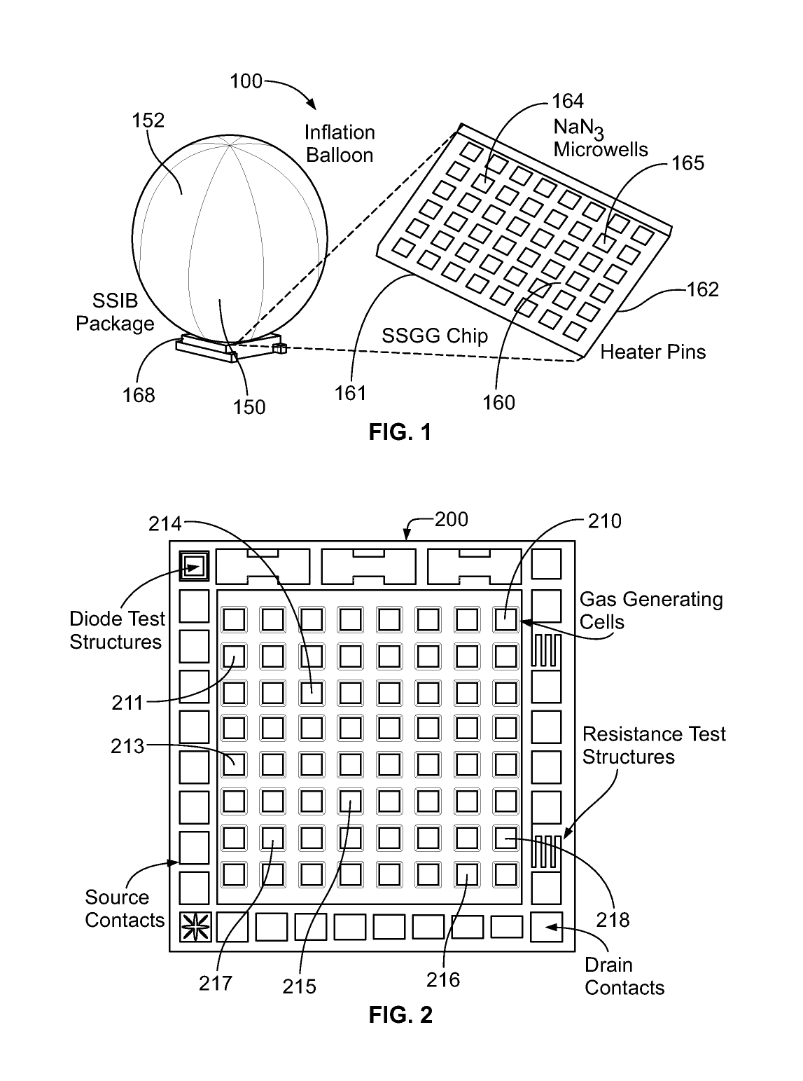

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In a preferred embodiment, the present invention provides a device and method that creates system 100 that may be used to generate a gas to inflate an inflatable structure. A typical use for such a device with an extraterrestrial device is to reduce the orbital lifetimes of small spacecraft (<180 kg) after their useful life has ended.

System 100 may include Solid-State Inflation Balloon (SSIB) deorbiter 150, that includes gas producing chip 160, which in a preferred embodiment, is of a solid-state design. Chip 160 may also include heater pins 162 as well as a plurality of microwells 164-165 (enlarged for illustration purposes).

SSIB 150 is a spacecraft subsystem designed to be a “plug-and-play” device to add to a spacecraft (not shown). The SSIB may be used to reduce orbital lifetime by inflating an inflatable structure such as balloon 152 with a surface area significantly larger than that of the spacecraft. The balloon causes extra aerodynamic drag on the spacecraft leading to lower orbital energy and a lower orbital height. The enhanced surface area causes the spacecraft to lose orbital energy and burn up in the atmosphere significantly faster than is natural without the enhanced area.

In a preferred embodiment, SSIB 150 is comprised of four primary components. Gas generator 160, an electronics control board 161, an inflatable structure having an interior space in communication with the gas created by gas generator 150 and a subsystem package 168. In a preferred embodiment, inflatable structure 152 may be an inflation balloon 152 that may be extraterrestrially deployed.

Gas generator 160 may be a MEMS device in yet another preferred embodiment. Gas generator 160 may be configured to generate numerous digital volumes of gas on-demand and can be customized to generate impulse bits of gas ranging from 1 μg-1 mg.

Electronics control board 168 handles communication with the spacecraft and delivers power to gas generator 160 during deployment of balloon 152. Inflation balloon 152 may be of a number of designs but a “party balloon” style balloon is preferred and may be made of thin polymer sheets (Mylar, Teflon, Kapton, etc.).

The subsystem package 168 may be an aluminum case that contains all the system components into a concise system.

In yet other embodiments, the present invention provides a device and method for inflating structures in space by serially generating small discrete amounts of gas using a solid-state system with no moving parts. In a preferred embodiment, as shown in FIG. 2, gas generator 200 is a Micro-Electromechanical Systems (MEMS) device called the Solid-State Gas Generator (SSGG). Gas generator 200 is comprised of a plurality of cells 210-218 that form an array of gas generating cells. Each cell generates gas by heating a crystalline material that decomposes when heated. A preferred material that may be used is Sodium Azide (NaN₃) which thermally decomposes to form Nitrogen gas (N₂) and Sodium salts when the crystal temperature exceeds −350 C. The SSGG is capable of serially generating small amounts of gas on-demand and can be designed to generate 10's, 100's or 1000's of gas impulses. Furthermore, the inflation state of a structure can be maintained over time by generating additional impulses of gas. This method advances the current state of art by providing superior control of inflation state while reducing system complexity and increasing system reliability.

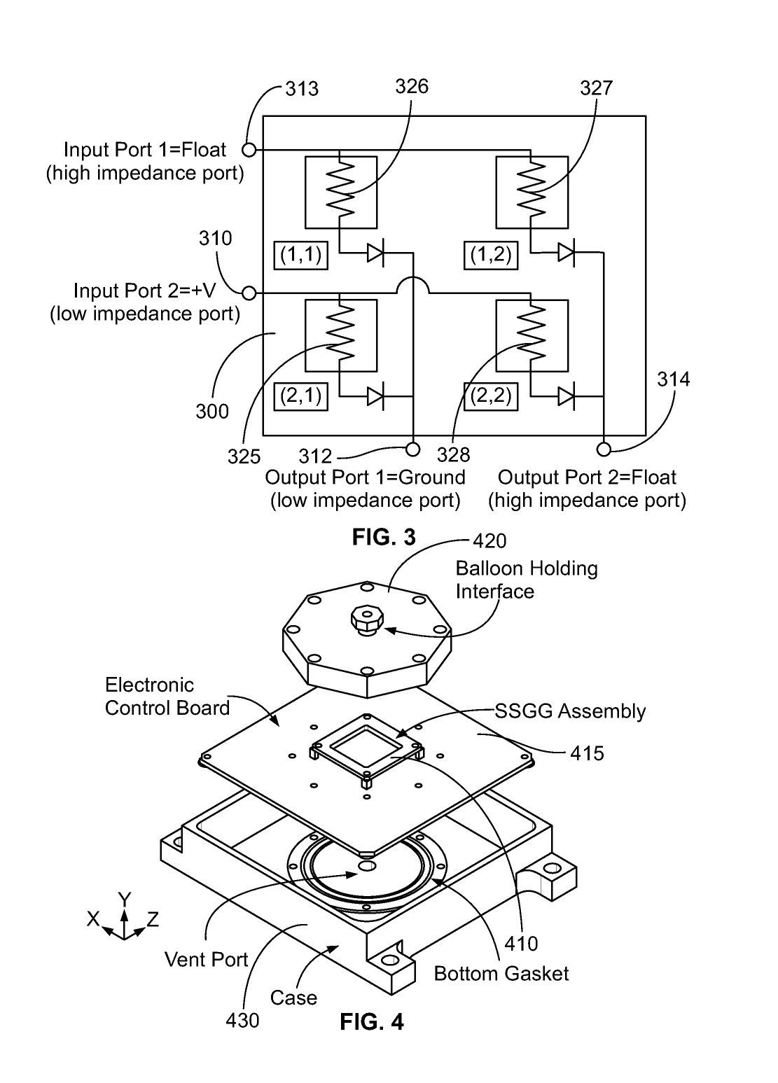

To deploy or generate gas from well 300, as shown in FIG. 3, a positive voltage is applied to the input port 310 while the output port 312 is grounded. All other ports 313-314 are left to float with high impedance. In this manner, the device generates gas by passing current through heater 325 thereby activating it. This results in activating only the desired well which then heats the NaN₃ causing it to thermally decay and release N₂ gas. Remaining inactive heaters 326-328 may be similarly activated as each is independently operable as described above.

In other aspects, the embodiments of the present invention may be used to inflate a structure to reduce the orbital lifetime of small spacecraft. However, there are alternate in-space uses of the embodiments of the present invention. The ability to reliably deploy a structure without mechanical actuators is valuable. Other applications for the embodiments of the present invention include deploying high gain antennas, differential drag devices for attitude control, and sensors such as magnetometers, among others.

Any inflatable structure on a spacecraft will be evacuated, folded, and stowed before the spacecraft is launched. Only after the spacecraft is on orbit will the inflatable be deployed. The entire reason an inflatable would be used is so that the spacecraft and all its systems take up minimal volume during launch. After the spacecraft is on orbit and ready to deploy, the embodiments of the present invention may be used.

As shown in FIG. 4, in a preferred method, a small amount of gas is first generated by gas generator 410, which is controlled in part by electronic controller 415, to begin the inflation and release of inflatable 420 from case or housing 430. Second, additional gas is generated to unfurl the folded inflatable. Third, more gas is generated to fully inflate the structure and bring the internal pressure up to its designed level. Fourth, the inflation state and pressure will be maintained over time by periodically generating additional gas to counteract any system leaks. Vent 430 may be provided for controlled deflation.

The invented method will advance the field of deployable structures in space by providing precise control over the inflation state of structures. Control over the inflation state is important for several key reasons. First, an over-pressurized structure could rupture, causing complete failure of the structure. Second, an under-pressurized structure will not work as designed. Third, deploying a structure too rapidly can lead to catastrophic dynamic pressures leading to the structure rupturing before it can be unfurled.

The embodiments of the present invention solve several problems by creating numerous small discrete impulses of gas. The embodiments allow for low dynamic pressures since the gas generation rate can be easily controlled. The structure will not be over pressurized because only the necessary amount of gas will be generated. Under-inflation is avoided because the gas generating system will be sized to be able to provide a more than sufficient amount of gas for complete inflation.

In other aspects, the present invention uses a Solid-State Gas Generator (SSGG). The SSGG is a MEMS device that contains an array of gas generating cells. The device is created using successive thin film and thick film depositions and patterning. A plurality of layers may be used to create the device. One or more layers may be made of Chrome and Gold and form the device contacts, conductors, and microheaters. One or more layers may also be made of Metal-Insulator-Metal diode (currently using Gold-Alumina-Aluminum). This allows for each well to be individually addressed with input and output ports in a similar manner as in S-RAM. One or more layers may be further made of an insulator that allows for conductor traces to cross over one another. The insulating layer is made of Silicon Nitride and deposited through plasma enhanced chemical vapor deposition. One or more layers may additionally be an additional conductor layer that completes the circuits of the device. The conductor layers are thin films deposited through physical vapor deposition by an electron beam evaporator and are patterned by a lift-off process. A final layer may be a thick film of SU-8 epoxy polymer this layer is patterned through photolithography and forms deep wells which can be loaded with NaN₃.

The amount of gas each well can generate is determined by the size and depth of these wells. The number and size of the gas generating wells, and thus the amount of gas that can be generated, is scalable. The device may be configured hold 100's or 1000's of discrete gas generating wells.

In other embodiments, the present invention may provide a heater for each well (less the diodes) and/or be configured to heat the material such as azide confined in each well. In yet other embodiments, the shape of the wells may be of any desired shape needed.

In other embodiments, the present invention provides a micro gas generator having a housing and a plurality of heating units contained in the housing. The heating units may be independently operable. Other embodiments may include a gas generator where each of the heating units consists of a heating element and gas producing material.

The heating units are in communication with an inflatable structure to be inflated. The heating units are also designed to be operable to release the gas into an interior portion of the inflatable structure by heating the gas producing material.

In other embodiments, the present invention provides a micro gas generator having an array of gas generating cells with a gas generating material located in a portion of each cell. Also provided are a plurality of input ports, output ports and microheaters. Each cell is configured to be in communication with an input port, an output port and a microheater.

In other embodiments, the present invention selectively activates predetermined heating units to release a predetermined amount of gas into the interior of an inflatable structure. In other embodiments, the heating units are activated serially. Gas may also be directly released into an inflatable structure in impulse bits of gas ranging from 1 μg to 1 mg. In other aspects, the gas is directly discharged into the inflatable structure without passing through a moving part such as a valve and without exhausting the supply of gas producing material.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A micro gas generator comprising:
a housing;
a plurality of heating units contained in said housing; and
said heating units independently operable.

2. The gas generator of claim 1 wherein each of said heating units contains a heating element and gas producing material.

3. The gas generator of claim 2 wherein each of said heating units includes a well, each of said wells contain said gas producing material.

4. The gas generator of claim 3 wherein said gas producing material is a crystalline structure.

5. The gas generator of claim 4 wherein said crystalline structure is Sodium Azide (NaN₃).

6. The gas generator of claim 3 wherein said heating units are in communication with an inflatable structure, said heating units operable to release a gas into an interior portion of said inflatable structure by heating said gas producing material and said gas passes directly into said interior portion without passing through any moving parts.

7. The gas generator of claim 3 wherein said heating units are in communication with an inflatable structure, said heating units operable to release a gas into an interior portion of said inflatable structure by heating said gas producing material and said gas passes directly into said interior portion without passing through any moving parts and without exhausting the supply of said gas producing material.

8. A micro gas generator comprising:
an array of gas generating cells;
a gas generating material located in a portion of each of said cells;
a plurality of input ports, output ports and microheaters;
each cell in communication with an input port, an output port and a micro heater;
said array comprised of a plurality of layers;
at least one of said layers made of a metal, said metal forms said input ports, output ports and microheaters;
at least one of said layers form said sections of said cells that contain said gas generating materials; and
a controller in communication with said input and output ports, said controller configured to operate said micro heaters individually.

9. The gas generator of claim 8 wherein each of said heating units contains a heating element and gas producing material.

10. The gas generator of claim 9 wherein each of said heating units includes a well, each of said wells contain said gas producing material.

11. The gas generator of claim 10 wherein said gas producing material is a crystalline structure.

12. The gas generator of claim 11 wherein said crystalline structure is Sodium Azide (NaN₃).

13. The gas generator of claim 9 wherein said heating units are in communication with an inflatable structure, said heating units operable to release a gas into an interior portion of said inflatable structure by heating said gas producing material and said gas passes directly into said interior portion without passing through any moving parts.

14. The gas generator of claim 10 wherein said heating units are in communication with an inflatable structure, said heating units operable to release a gas into an interior portion of said inflatable structure by heating said gas producing material and said gas passes directly into said interior portion without passing through any moving parts and without exhausting the supply of said gas producing material.

15. A method of controlling the pressure of a gas inside of an inflatable structure during extraterrestrial deployment comprising the steps of:
connecting an inflatable structure having an interior portion to a housing;
a plurality of heating units held in position by said housing;
said heating units independently operable and include a material that generates a gas when heated; and
selectively activating predetermined heating units to release a predetermined amount of gas into said interior of said inflatable structure.

16. The method of claim 15 wherein one or more of said heating units are activated serially.

17. The method of claim 16 wherein said gas passes directly into said interior portion from said heating units without passing through any moving parts.

18. The method of claim 17 wherein said gas is generated in impulse bits of gas ranging from 1 μg to 1 mg.

19. The method of claim 17 wherein said gas is directly released into said inflatable structure without passing through a moving part.

20. The method of claim 17 wherein said gas is directly released into said inflatable structure from said heating units to said interior portion without passing through a moving part and without exhausting the supply of gas producing material.
